(19) United States
(12) Patent Application Publication
(10) Pub. No.: US 2006/0016048 A1
(43) Pub. Date: Jan. 26, 2006

(54) Pivotally mountable hinge part having quick assembly hinge sections and method of using same

(76) Inventor: Joseph M. DiMario, Troy, MI (US)

Correspondence Address: PPG Industries, Inc.;Intellectual Property Dept., One PPG Place, Pittsburgh, PA, 15272, US

(21) Appl. No.: 10/895,758

(22) Filed: Jul. 21, 2004

(51) Int. Cl. E05D 7/10

(52) U.S. Cl. 16/260

(57) ABSTRACT

In one non-limiting embodiment of the invention a window is pivotally mounted to the body of an automobile by a quick release hinge part. A pair of injectors are pivotally mounted to the body of the automobile and a pair of receivers are mounted a major surface of the window. Each of the injectors has a pair of flexible fingers having outwardly extending tabs, and each of the receivers has a passageway having a tab-engaging portion. The tabs of an injector are inserted into the passageway of a receiver into engagement with the tab-engaging portion to detachably secure the receiver and the injector together to pivotally mount the window to the automobile body. Moving the tabs out of engagement with the tab-engaging portion, and separating the injector and the receiver separates the receiver and the injector and separates the window from the automotive body.

### BACKGROUND OF THE INVENTION

1. Field of the Invention

This invention relates to a pivotally mountable hinge part having quick assembly members for pivotally mounting a rigid substrate, e.g. pivotally mounting a window to an automotive body, and more particularly, to a pivotally mounted hinge part including an injectable member or injector optionally pivotally mounted to the back end of an automobile inserted into a receiving member or receiver optionally mounted on a rear automotive window, to secure, e.g. releasably secure, the receiver and injector together to pivotally mount the window to the automotive body. The invention also relates to a method of using the hinge part having the quick assembly members, i.e. the receiver and the injector.

2. Discussion of the Technology

Hinges of particular interest in this discussion include a first rigid hinge part and a second rigid hinge part. A side of each hinge part has spaced protrusions having a passageway. The protrusions of the parts interlock, and in an aligned position, a pin is inserted into the passageway to pivotally mount the hinge parts. As is appreciated by those skilled in the art, the first and second hinge parts can be plates secured to the pieces to be pivotally mounted together. In other instances, the protrusions having the passageway can be formed with one of the pieces to be pivotally mounted and the other hinge part joined to the other piece to be pivotally mounted. By way of illustration, an automotive body has the protrusions on which a hinge part is pivotally mounted formed as part of the automotive body and has hinge parts that are adhesively bonded to, welded to, bolted to, or screwed to the automotive body. The other hinge part can be secured to, or formed with, the piece to be pivotally mounted to the automotive body.

Consider now the arrangement for moveably mounting windows to automotive bodies. Automobiles are presently available with side doors and rear doors. The windows can be mounted on an elevator arrangement mounted within the door to move the windows up and down, the windows can be pivotally mounted to the automotive body, e.g. quarter panels mounted as discussed in U.S. Pat. No. 5,551,197, the windows can be pivotally mounted to the window opening of sliding side door, the windows can be pivotally mounted to the window opening of the rear door and/or the window can be pivotally mounted to the rear portion of the automotive body. Of interest in this discussion is the replacement of windows that are pivotally mounted in the window opening of the automotive body or pivotally mounted to the automotive body.

More particularly, in the instance where the hinge pivotally mounting the window is adhesively bonded to the rear window, the window is replaced by removing the fastener that pivotally mounts the window to the automotive door or to the automotive body. In the instance when the window is secured to the hinge by mechanical fasteners, e.g. a nut and bolt assembly, the nut and bolt assembly of each hinge is separated to replace the broken window with a new window. Windows having the hinge part secured by mechanical fastener have an additional limitation. More particularly, over tightening the nut and bolt arrangement can result in breaking the glass window. The replacement of windows that are pivotally mounted at the same pivot position as the automotive door, e.g. the rear door, such that the window can be opened and closed with the door in the closed position and can be opened with the door in the open position, is more labor intensive because the pin that pivotally mounts the hinge part for the door and for the window has to be removed to remove the broken window and inserted to pivotally mount the door and the replacement window.

As can be appreciated, it would be advantageous to provide a hinge part that does not have the limitations of the presently available hinge parts used to pivotally mount pieces together, e.g. pivotally mount windows to automotive bodies or to window openings of doors.

### SUMMARY OF THE INVENTION

The present invention relates to a hinge part comprising: a first member having a first side and an opposite second side, and a channel extending from the first side toward the second side; a detachably securing arrangement having a first part and a second part, the first part of the securing arrangement accessible through the channel of the first member; a second member having a first end portion and an opposite second end portion, wherein the first end portion of the second member comprises the second part of the securing arrangement, the first end portion of the second member and the channel of the first member sized relative to one another such that the first end portion of the second member is insertable into the channel of the first member for the first part and the second part of the securing arrangement to engage one another, and the second side of the first member or the second end portion of the second member having a shaft receiving orifice to mount the second side of the first member or the first end portion of the second member. In one nonlimiting embodiment of the invention, the first member is defined as a receiver, the second member is defined as an injector; the channel is a passageway, the second part of the securing arrangement at the first end portion of the injector comprises at least one flexible finger having an enlarged portion defined as a tab, and the first part of the securing arrangement comprises a tab engaging portion to engage the tab of the at least one flexible finger.

The present invention also provides a hinge part comprising: a receiver having a passageway extending from one end of the receiving member towards an opposite end, an opening in a side of the receiving member extending from the side to the passageway and a flexible member mounted at one end to the side of the receiving member and having a ridge at the other end, the flexible member in the unbiased position having the ridge extending into the passageway; an injector having a first end portion and an opposite second end portion, the first end portion having a sloping surface toward a first end of the injector and a groove spaced from the first end, the first end portion sized to be inserted into the receiving member, wherein as the first end moves into the passageway of the receiving member, the ridge is moved against biasing action of the flexible member until the groove of the injector is aligned with the ridge at which time the ridge moves into the groove by the biasing action of the flexible member to releasably secure the receiver and the injector together, and the receiver or the injector having a shaft-receiving orifice to mount the receiver or the injector

The present invention further provides a hinge part comprising: a first member and a second member, the first and second member each having a first end portion and an opposite second end portion with a center portion between the end portions, the center portion of the first and second members having a saw tooth surface with the saw tooth surface of the first member and the saw tooth surface of the second member sized to inter lock with one another and the end portions having a securing arrangement to secure the first member to the second member with the saw tooth surfaces interlocked, and the first or the second member having a shaft engaging portion to pivotally mount the member having the shaft engaging portion.

Another nonlimiting embodiment of the invention provides a hinge part comprising: a first member having a first end portion and an opposite second end portion and a center portion between the end portions of the first member; a second member having a first end portion and an opposite second end portion and a center portion between the end portion of the second member surface; a first part of a Velcro strip secured to the center portion of the first member; a second part of the Velcro strip on the center portion of the second member; a two part first engaging arrangement, the first part of the first engaging arrangement mounting the first end portion of the first member and the second part of the first engaging arrangement mounting the first end portion of the second member; a two part second engaging arrangement, the first part of the second engaging arrangement mounting the second end portion of the first member and the second part of the second engaging arrangement mounting the second end portion of the second member; and the first member or the second member having a shaft engaging portion to mount the first member or the second member having the shaft engaging portion.

The present invention also provides an article comprising: a sheet member having a surface, the sheet member selected from the group of windows, doors, pivotally mount rigid substrates and combinations thereof and the sheet member made of a material selected from glass, glass ceramic, plastic, wood, metal, composite material and combinations thereof; and at least one hinge part mounted on the surface of the sheet member, the hinge part selected from: (1) a receiver having a first side and an opposite second side, and a passageway extending from the first side toward the second side; a tab engaging portion in the passageway, wherein the tab engaging portion is selected from a nib extending into the passageway, an opening in a wall of the passageway to receive a tab of a flexible finger, a portion of the passageway having a decreasing spacing between spaced walls of the passageway as the distance from the first end of the receiver increases to a transition area where the spaced distance between the spaced wall increase to provide a ledge within the passageway, and combinations thereof, and (2) an injector having a first end portion and an opposite second end portion, wherein the first end portion comprises an attachment member having at least one flexible finger having an enlarged end portion.

The present invention further provides an article comprising: a sheet member having a surface, the sheet member selected from windows, doors, pivotally mount rigid substrates and combinations thereof and the sheet member made of a material selected from glass, glass ceramic, plastic, wood metal and combinations thereof; and at least one hinge part mounted on the surface of the sheet member, the hinge part selected from: (1) a receiver having a passageway extending from one end of the receiving member toward an opposite end, an opening in a side of the receiving member extending from the side to the passageway, and a flexible member mounted at one end to the side of the receiving member and having a ridge at the other end, the flexible member in the unbiased position having the ridge extending into the passageway and (2) an injector having a first end portion and an opposite second end portion, the first end portion having a sloping surface toward a first end of the injector and a groove spaced from the first end.

Another nonlimiting embodiment of the present invention provides an article comprising: a sheet member having a surface, the member selected from windows, doors, pivotally mount rigid substrates and combinations thereof and the sheet member made of a material selected from glass, glass ceramic, plastic, wood metal and combinations thereof; and at least one hinge part mounted on the surface of the sheet member, the hinge part comprising a member having a first end portion and an opposite second end portion with a center portion between the end portions, the center portion having a saw tooth surface with the saw tooth surface and the end portions of the member having a part of a two part securing arrangement.

The present invention also provides an article comprising: a sheet member having a surface, the member selected from windows, doors, pivotally mount rigid substrates and combinations thereof and the sheet member made of a material selected from glass, glass ceramic, plastic, wood metal and combinations thereof; and at least one hinge part mounted on the surface of the sheet member, the hinge part having a first end portion and an opposite second end portion and a center portion between the end portions, a first part or a second part of a Velcro strip secured to the center portion of the hinge part, and one part of a two part first engaging arrangement positioned on the first end portion of the hinge part and one part of a two part second engaging arrangement positioned on the second end portion of the member.

The present invention provides in a vehicle of the type having a part that is pivotally mounted by a mounting arrangement comprising at least one hinge part mounted to a surface of the part and pivotally mounted to the vehicle body or pivotally mounted to a component mounted to body of the vehicle, the improvement comprising: a quick release hinge part comprising a first member, a second member, and a releasably securing arrangement, with the first member or the second member mounted to the surface of the part and the second member or the first member, respectively, pivotally mounted to the vehicle body or a component mounted to the vehicle body, wherein the first member has a first side and an opposite second side, and a passageway extending from the first side toward the second side; the detachably securing arrangement has a first part and a second part, the first part of the securing arrangement accessible through the passageway of the first member; the second member has a first end portion and an opposite second end portion, wherein the first end portion of the second member comprises the second part of the securing arrangement, the first end portion of the second member and the passageway of the first member sized relative to one another such that the first end portion of the second member is insertable into the passageway of the first member for the first part and the second part of the securing arrangement to engage one another; and the second side of the first member or the second end portion of the second member pivotally mounted to the vehicle body or pivotally mounted to a component mounted to the vehicle body.

The present invention further provides in a vehicle of the type having a part that is pivotally mounted by a mounting arrangement comprising at least one hinge part mounted to a surface of the part and pivotally mounted to the vehicle body or pivotally mounted to a component mounted to the vehicle body, the improvement comprising: a quick release hinge part comprising a receiver and an injector with the receiver or the injector mounted to the surface of the part and the injector or the receiver, respectively, pivotally mounted to the vehicle body or a component mounted to the vehicle body, wherein the receiver has a passageway extending from one end of the receiving member towards an opposite end, an opening in a side of the receiving member extending from the side to the passageway and a flexible member mounted at one end to the side of the receiving member and having a ridge at the other end, the flexible member in the unbiased position having the ridge extending into the passageway; the injector has a first end portion and an opposite second end portion, the first end portion having a sloping surface toward the first end of the attachment member and a groove spaced from the first end, the first end portion sized to be instead into the receiving member, wherein as the first end moves into the passageway of the receiving member the finger is moved against biasing action of the flexible member until the groove of the attachment member is aligned with the ridge at which time the ridge moves into the groove by the biasing action of the finger to secure the receiving member and the attachment member together; and the receiver or the injector has a shaft-receiving orifice to mount the receiver or the injector.

In another nonlimiting embodiment, the present invention provides in a vehicle of the type having a part that is pivotally mounted by a mounting arrangement comprising at least one hinge part mounted to a surface of the part and pivotally mounted to the vehicle body or pivotally mounted to a component mounted to the vehicle body, the improvement comprising: a quick release hinge part comprising a first member and a second member with the first member or the second member mounted to the surface of the part and the second member or the first member, respectively, pivotally mounted to the vehicle body or a component mounted to the vehicle body, wherein the first and second members each have a first end portion and an opposite second end portion with a center portion between the end portions, the center portion of the first and second members having a saw tooth surface with the saw tooth surface of the first member and the saw tooth surface of the second member sized to inter lock with one another and the end portions having a securing arrangement to secure the first member to the second member with the saw tooth surfaces interlocked; and the first or the second member having a shaft engaging portion to pivotally mount the member having the shaft engaging portion.

The present invention also provides a vehicle of the type having a part that is pivotally mounted by a mounting arrangement comprising at least one hinge part mounted to a surface of the part and pivotally mounted to the vehicle body or pivotally mounted to a component mounted to the vehicle body, the improvement comprising: a quick release hinge part comprising a first member and a second member with the first member or the second member mounted to the surface of the part and the second member or the first member, respective pivotally mounted to the vehicle body or a component mounted to the vehicle body, wherein the first member has a first end portion and an opposite second end portion and a center portion between the end portions of the first member; the second member has a first end portion and an opposite second end portion and a center portion between the end portion of the second member surface; a first part of a Velcro strip secured to the center portion of the first member; a second part of the Velcro strip on the center portion of the second member; a two part first engaging arrangement, the first part of the first engaging arrangement mounting the first end portion of the first member and the second part of the first engaging arrangement mounting the first end portion of the second member; a two part second engaging arrangement, the first part of the second engaging arrangement mounting the second end portion of the first member and the second part of the second engaging arrangement mounting the second end portion of the second member; and the first member or the second member having a shaft engaging portion to pivotally mount the first member or the second member having the shaft engaging portion.

The present invention also provides a method of separating a first and second article, the first article pivotally mounted to the second article, the first article made of a material selected from the glass, glass ceramic, plastic, wood, metal, composite material and combinations thereof, the first article having a first section of a hinge part mounted on a surface of the first article and the second article has an end portion of a second section of the hinge part mounted thereto, the first and second sections of the hinge part are detachable secured to each other by at least one flexible finger attached to the first or second section of the hinge part, and the second or first section of the hinge part, respectively, having a finger engaging portion, wherein the finger engaging portion engages the finger, comprising the steps of: moving the at least one finger away from the finger engaging portion defined as a first moving step; while moving the first and second sections of the hinge part relative to one another defined as a second moving step to separate the first and second sections of the hinge part. In one nonlimiting embodiment, the first section of the hinge part is a receiver having the finger engaging portion, the end portion of the second section of the hinge part is pivotally mounted to the second article, and the second section of the hinge part is an injector having the at least one finger; the hinge part is a first hinge part, and further comprising a second hinge part having a receiver having a finger engaging portion and an injector having at least one flexible finger and an end portion with the end portion of the injector of the second hinge part pivotally mounted to the automobile body spaced from the injector of the first hinge part and the method further comprises the step of after the practice of the first moving step, moving the at least one finger of the injector of the second hinge away from the finger engaging portion of the receiver of the second hinge and moving the receiver and the injector of the second hinge part relative to one another defined as third moving step to separate the injector and the receiver of the second hinge part.

The present invention further provides a method of securing a first article to a second article, the first article made of a material selected from glass, glass ceramic, plastic, wood metal and combinations thereof, the first article having a first section of a hinge part mounted on a surface of the first article and the second article has a portion of a second section of the hinge part mounted thereto, the first and second sections of the hinge part are detachable secured by at least one flexible finger attached to the first or second section of the hinge part, and the second or first section of the hinge part, respectively, having a finger engaging portion, wherein the finger engaging portion engages the finger, comprising the step of: moving the finger and the finger engaging portion toward and into engagement with one another to secure the first and second sections of the hinge part together.

### BRIEF DESCRIPTION OF THE DRAWING

FIG. 1 is an elevated frontal view of the back end of an automobile showing a rear window in the open position and the door in the closed position, the window pivotally mounted to the automotive body by a pair of spaced hinge parts each having quick-assembly receiver and injector incorporating features of the invention.

FIG. 2 is an enlarged fragmented view of a door and window pivot position showing the quick assembly receiver and injector incorporating features of the invention pivotally mounted the rear window to the automotive body.

FIG. 3 is a view taken along lines 3-3 of FIG. 2.

FIG. 4 is an elevated fractured plan view of the window shown in FIG. 1.

FIG. 5 is an orthogonal view having portions removed for purposes of clarity of a non-limiting embodiment of a hinge part having the quick assembly receiver and injector incorporating features of the invention in a non-engaging position.

FIG. 6 is an elevated fragmented front view having portions removed for purposes of clarity of another non-limiting embodiment of a hinge part having the quick assembly receiver and injector incorporating features of the invention in a non-engaging.

FIG. 7 is a view similar to the view of FIG. 6 showing still another non-limiting embodiment of a hinge part having the quick assembly receiver and injector incorporating features of the invention.

FIG. 8 is an elevated front view of a further non-limiting embodiment of a hinge part having the quick assembly including one receiver and two injectors incorporating features of the invention in an engaging position.

FIG. 9 is a view similar to the view of FIG. 8 showing a still further non-liming embodiment of a hinge part having the quick assembly receiver and injector incorporating features of the invention in an engaging position.

FIG. 10 is an orthogonal view of another non-limiting embodiment of a hinge part having the quick assembly receiver and injector incorporating features of the invention in a non-engaging position.

FIG. 11 is a side elevated sectional view of the quick assembly receiver and injector shown in FIG. 10 in the engaging position.

FIG. 12 is an orthogonal view of another non-limiting embodiment of a hinge part having the quick assembly receiver and injector incorporating features of the invention in a non-engaging position.

FIG. 12A is an exploded view of an end portion of the receiver shown in FIG. 12.

FIG. 13A is a view taken along line 13A of FIG. 12.

FIG. 13B is a view similar to the view of FIG. 13A showing the end portion of the injector in the receiver.

FIG. 13C is a view similar to the view of FIG. 13A showing the injector engaging the receiver in accordance to the teachings of the invention and showing in phantom non-limiting arrangements to limit movement of the end portion of the injector.

FIG. 14 is a sectional side elevated view of still another embodiment of a hinge part incorporating features of the invention with the quick assembly receiver and injector in the engaging position and having the same surface configuration.

FIG. 15 is a side elevated view of a further non-limiting embodiment of a hinge part incorporating features of the invention with the quick assembly receiver and injector in the engaging position.

FIG. 16 is a fragmentary perspective view of a side window, and side door having a window, pivotally mounted in accordance to non-limiting embodiments of the invention.

FIG. 17 is a side elevational view of the inner surface of the side window shown in FIG. 16.

FIG. 18 is a view taken along lines 18-18 of FIG. 17.

FIG. 19 is an elevated partial front view in cross section of another non-limiting embodiment of a hinge part having the quick assembly receiver and injector of the invention.

### DETAILED DESCRIPTION OF THE INVENTION

The non-limiting embodiments of the hinge part having the quick-assembly receiving member or receiver and injectable member or injector incorporating features of the invention discussed below are directed to pivotally mounting windows to vehicular bodies, e.g. a lift gate window to the rear of an automobile, quarter panels to automotive bodies and/or windows in the window openings of a slideable automotive door; however, as will be appreciated, the invention is not limited thereto and can be used to pivotally mount any two or more parts or pieces together, e.g. a door to a door frame, a residential window to a fenestration and a lid to the body of a container to name a few. Further the invention is not limited to pivotally mounting a window to an automobile and can be used to pivotally mount a window to any type of vehicle, e.g. a land vehicle, an above or below water vehicle, an air vehicle or a space vehicle and combinations thereof. Still further, in the discussion of the invention, the window is a glass window; however the invention is not limited to the material of the window, and the window can be any type of material, e.g. plastic, clear glass, colored glass, coated glass, ceramic, glass ceramic, metal, wood, composite materials and combinations thereto. In addition, in the discussion of the invention, the window is a single piece of shaped tempered glass; however the invention is not limited thereto and can be flat tempered glass, shaped or flat annealed or heat strengthened glass, laminated glass, laminated glass and plastic plies, a pair of glass sheets separated by a spacer and combinations thereof.

The following discussion of the invention is directed to one hinge part, and the invention is not limited to the configuration and design of the other hinge part. For example, but not limiting to the invention, the other hinge part can have the quick assembly receiver and injector of the invention, or the protrusion of the other hinge part having the passageway to receive the pin to pivotally mount the hinge parts together can be formed with the piece to be joined, e.g. formed with the automotive body.

In the following discussion of non-limiting embodiments of the invention, spatial or directional terms, such as “inner”, “outer”, “left”, “right”, “up”, “down”, “horizontal”, “vertical”, and the like, relate to the invention as it is shown in the drawing figures. However, it is to be understood that the invention can assume various alternative orientations and, accordingly, such terms are not to be considered as limiting. Further, all numbers expressing dimensions, physical characteristics, and so forth, used in the specification and claims are to be understood as being modified in all instances by the term “about”. Accordingly, unless indicated to the contrary, the numerical values set forth in the following specification and claims can vary depending upon the desired properties sought to be obtained by the practice of the invention. At the very least, and not as an attempt to limit the application of the doctrine of equivalents to the scope of the claims, each numerical parameter should at least be construed in light of the number of reported significant digits and by applying ordinary rounding techniques. Moreover, all ranges disclosed herein are to be understood to encompass any and all subranges subsumed therein. For example, a stated range of “1 to 10” should be considered to include any and all subranges between (and inclusive of) the minimum value of 1 and the maximum value of 10; that is, all subranges beginning with a minimum value of 1 or more and ending with a maximum value of 10 or less, and all subranges in between, e.g. 1 to 6.3, or 5.5 to 10, or 2.7 to 6.1. Also, as used herein, terms such as “positioned on” or “supported on” mean positioned or supported on but not necessarily in direct surface contact with. For example, a window “positioned on” or “positioned against” an opening in an automotive window does not preclude the presence of one or more other materials located between the window and the opening.

Further, in the discussion of the non-limiting embodiments of the invention, it is understood that the invention is not limited in its application to the details of the particular non-limiting embodiments shown and discussed since the invention is capable of other embodiments. Further, the terminology used herein is for the purpose of description and not of limitation, and unless indicated otherwise, like reference numbers refer to like elements.

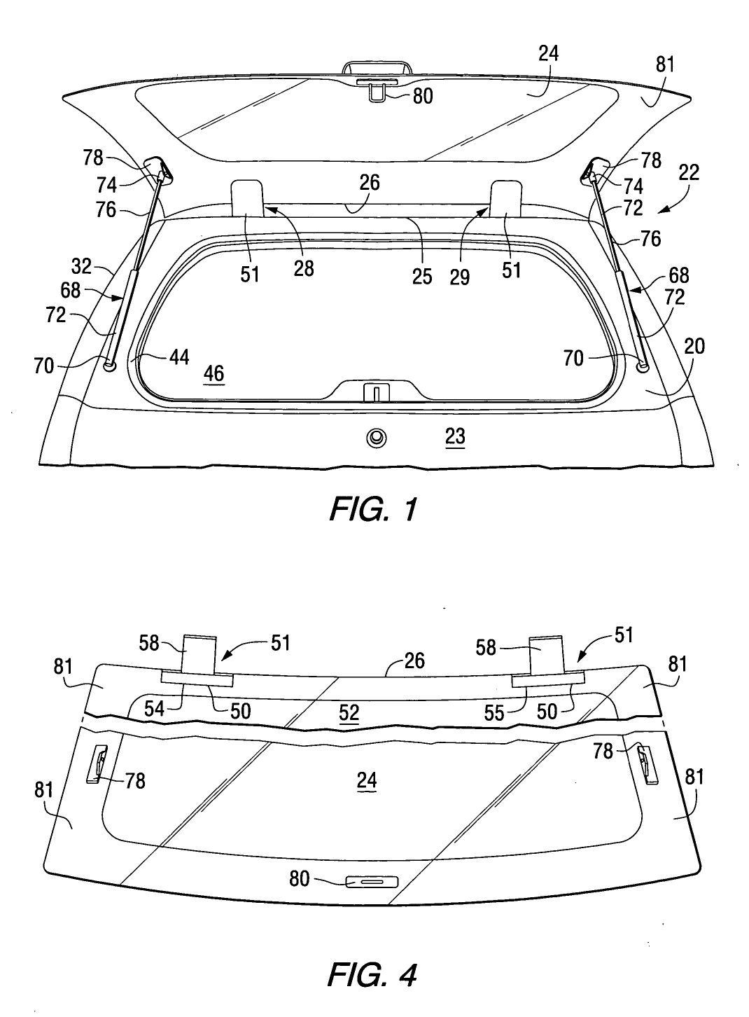

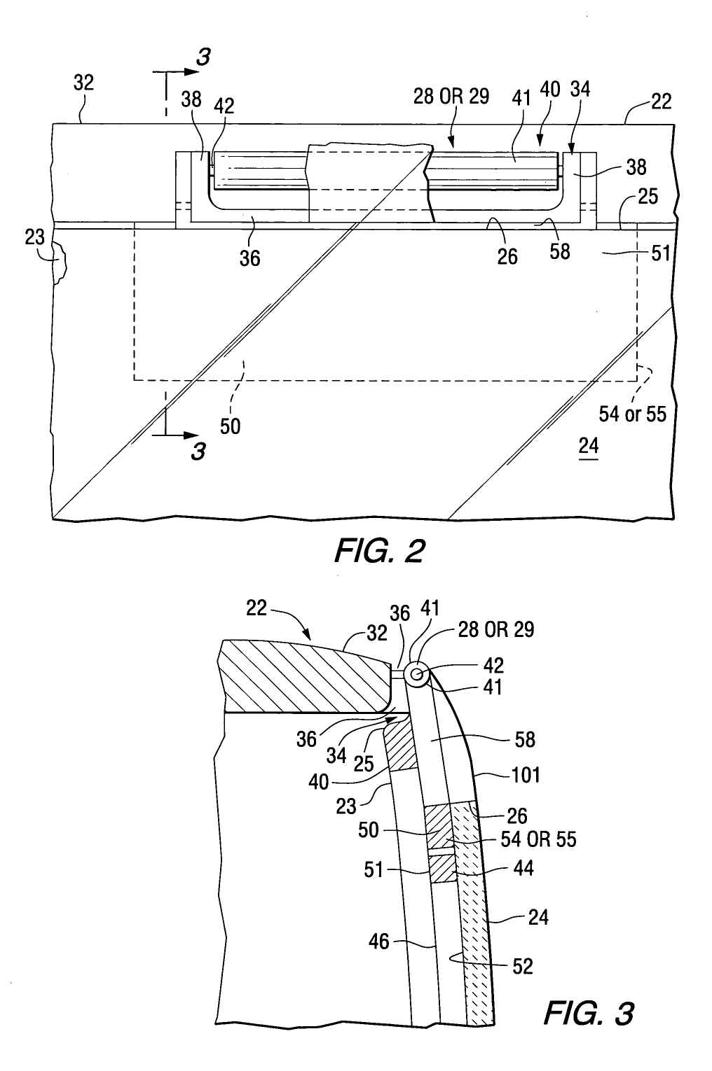

There is shown in FIG. 1 rear entrance 20 of an automobile 22. The rear entrance 20 includes a door 23 and a rear window 24. The upper side 25 of the door 23 and the upper marginal edge 26 of the rear window 24 are pivotally mounted at 28 and 29 to body 32 of the automobile. In the practice of the invention, the door 23 is pivotally mounted to the body 32 at the rear entrance 20 in any usual manner, and the window 24 is pivotally mounted to the automotive body 32 in accordance to the invention in a manner discussed below. With particular reference to FIGS. 2 and 3 and not limiting to the invention, the door 23 is pivotally mount to the body 32 of the automobile by providing a hinge component or part 34, e.g. a U-shaped member 36 having outer legs 38 to the top side 40 of the door 23, and providing a cylindrical member 41 to top of the automotive body 32 at the rear entrance. A pin 42 passing through holes (not shown) in the spaced legs 38 of the U-shaped member 36 and passageway in the cylindrical member 41 pivotally mounts the door 24 to the body 32 of the automobile 22.

A flexible gasket 44 is mounted in the door 23 around opening 46 as shown in FIG. 1. With the window 24 in the closed position as shown in FIG. 3, the window engages the gasket to prevent water moving into the automobile interior.

With reference to FIGS. 1-4 as needed and not limiting to the invention, receiver 50 of hinge part 51 of the invention is securely mounted on inner surface 52 of the window 24 at each of two spaced positions 54 and 55 adjacent upper marginal edges 26 the window 24. Preferably the receiver 50 is mounted above the gasket 44 as shown in FIG. 3 to provide the water seal discussed above. The positions 54 and 55 on the inner surface 52 of the rear window 24 are aligned with ones of the pivot positions 28 and 29, respectively. Injector 58 of the hinge part 51 of the invention is connected to the receiver 50 in a manner discussed below and pivotally mounted to the cylindrical member 41 by the pin 42 (see FIGS. 2 and 3) in a manner discussed below to provide for pivoting the window upwardly when the door 24 is opened and for pivoting the window upwardly and downwardly when the door is in a position other than the open position, e.g. the closed position.

With reference to FIGS. 1 and 4, as can be appreciated by those skilled in the art and not limiting to the invention, a piston 68 is provided at each side of the rear window 24 for ease of opening and closing the rear window and for maintaining the window in the open position. One end 70 of piston cylinder 72 of the piston 68 is pivotally mounted to the door 23, and end 74 of piston rod 76 is pivotally mounted in any convenient manner to plate 78 securely mount to the inner surface 52 of the window 24. A latch 80 is securely mounted to the inner surface 52 of the window 24 to lock the window in the closed position. The piston 68, plate 78 and latch 80 are not limiting to the invention and any type of locking arrangement to secure the window to the door and for biasing the window to the open position and to maintain the window in the open position can be used in the practice of the invention. In view of the foregoing, no further discussion regarding the piston 68, plate 78 and latch 80 is deemed necessary.

For aesthetics and not limiting to the invention, a black ceramic band 81 is applied to the inner surface 52 of the window 24 to obscure, among other things, the receiver 51, the piston 68, the piston cylinder 72, the plate 78 and the latch 80.

As can now be appreciated, the invention is not limited to mounting the receiver on a surface of the window 24, and pivotally mounting the injector to the body 32 of the automobile 22. More particularly, the invention contemplates pivotally mounting the receiver of the hinge part of the invention to the body of the automobile and securing the injector to a surface of the window. The invention further contemplates making the part to be pivotally mounted to the automobile or pivotally mounted to a component of the automobile out of spring steel and providing the part with a “C” shape (see FIG. 18) to provide the pivoting action.

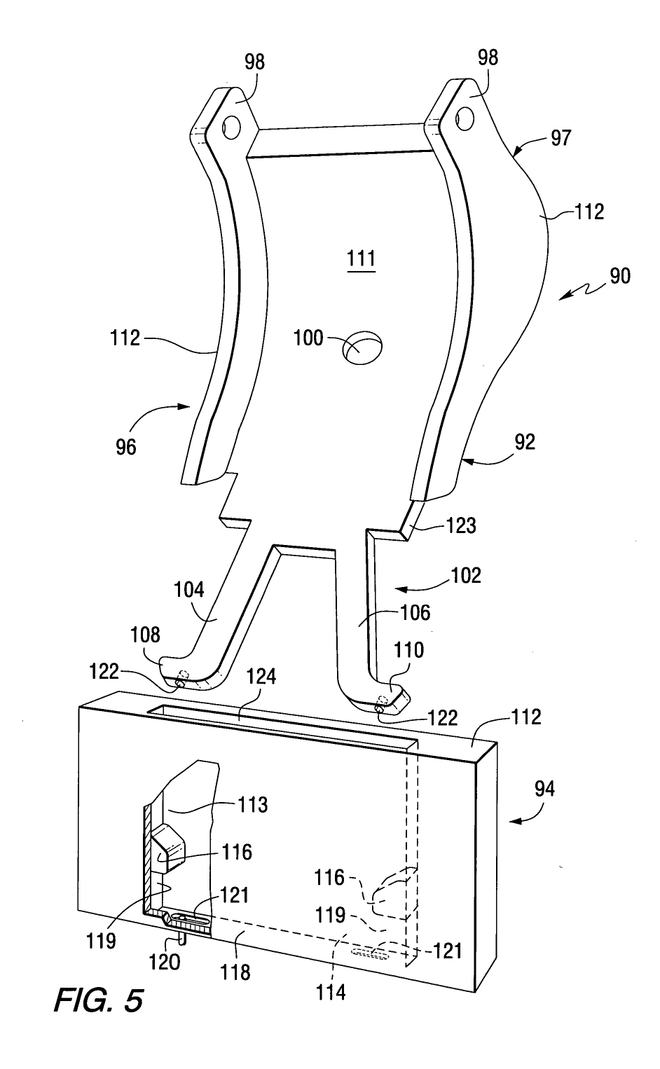

The discussion will now be directed to several non-limiting embodiments of the hinge part 51 having the quick-assembly receiver and injector of the invention shown in FIGS. 5-13; however, as can be appreciated, the invention is not limited thereto. The non-limiting embodiment of hinge part 90 shown in FIG. 5 includes an injector 92 and a receiver 94. The injector 92 includes a body 96 with upper end portion or upper end 97 of the body 96 having a pair of spaced extensions 98. The distance between the extensions 98 is equal to or greater that the length of the cylindrical member 41 mounted to the body 32 of the automobile 22, and the thickness of the outer legs 38 of the U-shaped hinge member 36 of the hinge part 34 mounted to the top of the door (see FIGS. 1 and 2). With this arrangement hinge part 90 of the invention, e.g. the injector 92 of the hinge part 90 can be pivoted about the pin 42 (see FIG. 3) to lift the rear window 24 toward and/or into the open position, and lower the rear window toward and/or into the closed position when the door is closed and/or when the door is being opened or closed. The body 96 of the injector 92 is shaped to provide a smooth transition from the cylindrical member 41 to the window 24. Although not limiting to the invention, the body 96 of the injector 92 has a hole 100 for securing a cover plate 101 (shown only in FIGS. 2 and 3) to the body 96 in any manner, e.g. by a nut and bolt assembly to cover the cylindrical member 41 and portions of the injector for an aesthetic appearance.

Lower end portion or opposite side 102 of the body 96 has a pair of spaced fingers 104 and 106. The distance between the fingers increases as the distance from the body 96 increases with the fingers terminating with outwardly extending tabs 108 and 110. The width and/or thickness of the fingers 104 and 106 are sized to move toward one another under a biasing force and to move back to the unbiased position after the biasing force is removed. For example and not limiting to the invention, an injector was molded from polybutylene terephthalate (also referred to as “PBT”). The fingers had a length of about 62 millimeters (“mm”) and a width of about 20 mm with a slight decrease in the width as the distance from the upper end 97 of the body 96 toward the tabs increases. The fingers adjacent the body 96 had a spaced distance of 40 mm and a spaced distance at the tabs of 63 mm. The fingers and tabs each had a thickness of about 5 mm.

Although not limiting to the invention, the portion 111 of the body 96 between the end portions 97 and 102 is recessed within sides 112 and co-operates with the cover plate 101 (see FIGS. 2 and 3) to receive the hinge part 34 of the door 23 for an aesthetic appearance.

The receiver 94 includes a passageway 113 extending from upper side 112 through body 114 of the receiver 94. Within the passageway are a pair of projections or nibs 116 facing one another, spaced from one another and spaced from the side 118, e.g. bottom side 118 as viewed in FIG. 5 a distance to receive the tabs 108 and 110 of the fingers 104 and 106 respectively. The passageway 113 is sized to receive the fingers in the unbiased position. As the tabs 108 and 110 of the fingers 104 and 106 move into the passageway 113, the tabs 108 and 110 engage their respective nib 116. Continued urging of the fingers into the passageway applies a biasing force to the fingers to move the fingers toward one another as the tabs slide over their respective nib. After the tabs of the fingers pass over the nibs, the fingers move away from one another to their unbiased position to move the tabs into groove 119 to releasably or detachably secure or lock the injector 92 and the receiver 94 together to provide a non-limiting embodiment of a hinge part having the quick assembly receiver and injector of the invention.

As can be appreciated, the invention is not limited to the process of making, or the material used in the process of making the receiver and the injector of the invention. For example and not limiting the invention thereto, the injector 92 and the receiver 94 can be made of any material, e.g. but not limiting the invention thereto metal, plastic, plastic reinforced fiberglass, composite material, wood or combinations thereof that can be flexed under a biasing force and after the biasing force is removed the fingers return to their unbiased position. Stated another way, the material selected should have a mechanical yield greater than the biasing force to be applied to the fingers. Further, the injector 92 and the receiver 94 can be made of the same material or different materials. The injector and the receiver can be made in any manner, e.g. the parts can be machined, formed, e.g. press formed, injection molded, cast, forged, extruded or pultruded, or assembled from machined or formed component parts. As can be appreciated in selecting the material and assembling the parts consideration has to be given to the structural stability of the design and material. In the practice of the invention the engaging member and receiver were formed by injection molding PBT purchased from GE Polymer. Regarding the structural stability of the design and stresses acting on the engaging member and the retentive member, computer programs are available to determine adequate design criteria. One such computer program is available from Altair Engineering of Troy, Mich., and is known by the name Hypermesh®.

The receiver 94 is securely mounted on the inner surface 52 of the window 24 (see FIG. 4) in any usual manner, e.g. but not limiting the invention thereto, holes can be drilled in the glass piece during the process for making the window 24, and a nut and bole assembly used to secure the receiver to the window, or the receiver can be adhered to the window using a layer of any type of adhesive or a double sided tape having any type of adhesive layer on each side. In the practice of the invention, a receiver of the type shown in FIG. 5 was secured to a glass window using a two-component urethane adhesive sold by Dow under the name of Betamate® 73100/73005.

The receiver 94 and the injector 92 are separated or released from one another in any convenient manner, e.g. but not limiting to the invention an elongated member 120 (only one shown in FIG. 5) is inserted into each of the slots 121 in the bottom side 118 of the receiver 94 and into hole 122 in the bottom of each tab 108 and 110 of the fingers 104 and 106, respectively. The elongated members 120 are moved toward one another to bias the fingers 104 and 106 toward one another to move the tabs 108 and 110 out of their respective groove 119, clear of their respective nib 116. The injector 92 and the receiver 94 are moved relative to one another, e.g. but not limiting to the invention, the receiver is moved away from the injector. After the tabs pass their respective nib, the elongated members 120 can be removed from their respective hole 122 in the tab and the slot 121 in the bottom side of the receiver. The fingers are removed from the passageway, and the receiver and the injector separated from one another.

It should be appreciated that in one nonlimiting embodiment of this invention, the fingers 104 and 106 can be mechanically biased toward each other to facilitate engaging tabs 108 and 110 with nibs 116 in a manner similar to that discussed above where the fingers 104 and 106 were mechanically biased to disengage tabs 108 and 110 from nibs 116.

As can be appreciated by those skilled in the art, the invention is not limited to the tool to bias the fingers 104 and 106 toward one another to separate the injector 92 and the receiver 94. For example but not limiting the invention thereto, the tool can use the mechanical arrangement of a pair of pliers to move the jaws of the pliers together. To move the tabs out of their respective groove, the jaws of the pliers would be replaced with, or reshaped to have the shape of, elongated members 120. Further the receiver 94 is shown in FIG. 5 to have a closed bottom side 118. As can be appreciated, the side 118 can be an open ended side of the passageway 113.

The hinge part of the invention having the quick assembly receiver and injector makes the removal and replacement of the rear window a simple process. More particularly, when the removal of the window is desired, e.g. to replace a damaged window, to carry cargo or for convenience, the end 74 of the piston rod 76 is removed from the plate 78, and the receiver and the injector separated as discussed above. A replacement window or the window removed is mounted to the injector by moving the fingers 104 and 106 of the injector into the passageway 113 of the receiver to move the tabs 113 into their respective groove 119 as discussed above. The end 74 of the piston rod 76 is connected to the plate. In the alternative, the end 70 of the piston 68 can be removed from the door to remove the piston 68 with the window.

Although not limiting to the invention and with continued reference to FIG. 5, the injector 92 can be provide with a plate member or collar 123 from which the fingers 104 and 106 extend. The collar 123 is sized to snugly fit into the passageway 113 at the side 112 of the receiver 94 when the tabs 108 and 110 of the fingers 104 and 106, respectively are in their respective groove 119. The collar 123 inserted into the receiver 94 limits rocking of the fingers 104 and 106 of the injector 92 when the injector is in engagement with the receiver 94.

In the discussion of the invention, the hinge part of the invention and the hinge part of the door are mounted on the same cylindrical member 41 by the same pin. The invention contemplates mounting the hinge part of the door and the hinge part of the invention on separate cylinders using the same pin or different pins. Further the invention contemplates mounting the receiver or the injector on the inside surface or the outside surface of the window.

As can now be appreciated, the quick release receiver and injector of the invention are contoured and fitted to blend in with the shape of the window and the contours of the automotive body parts to provide an atheistically pleasing appearance, an aerodynamically acceptable shape and to reduce stress on the parts of the hinge due to changes in contour. These features are well known in the art and no further discussion regarding these matters is deemed necessary.

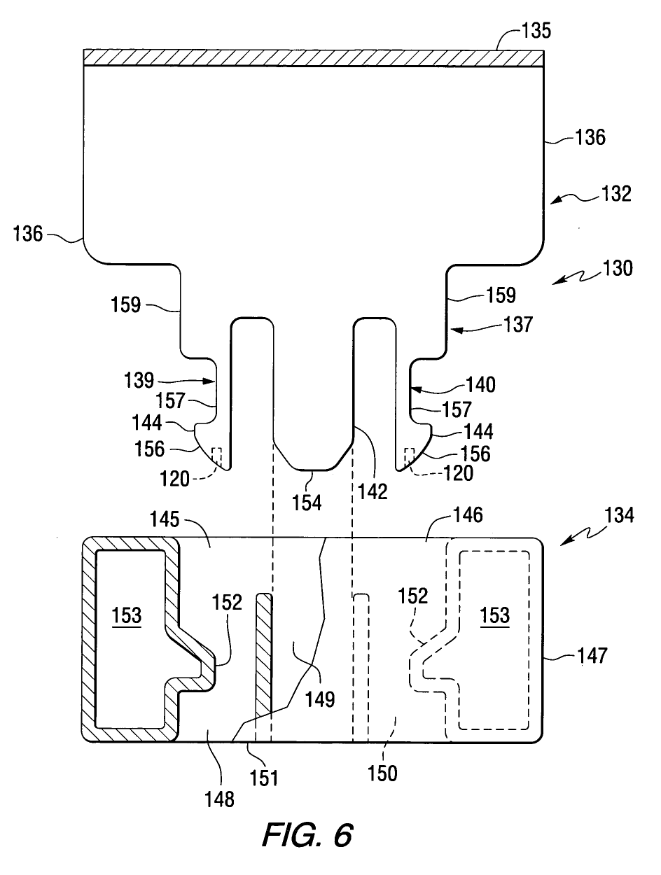

With reference to FIG. 6, there is shown another non-limiting embodiment of the hinge part having the quick assembly receiver and injector of the invention designated by the number 130. The hinge part 130 includes an injector 132 and receiver 134. Upper end portion 135 of body 136 of the injector 132 for pivotally mounting the hinge part 130 to the automobile body is not shown in FIG. 6; however, the discussion regarding the upper end portion 97 of the injector 92 shown in FIG. 5 and its attachment to the automobile body is applicable to attach the injector 132 to the automobile body. Lower end portion 137 of the body 136 of the injector 132 includes a pair of fingers 139 and 140 spaced from one another with an aligning member 142 between the fingers. Each of the fingers 139 and 140 has an outwardly extending tab 144.

The receiver 134 has a passageway 145 having an opening at side 146 of the receiver 137 and extends into body 147 of the receiver to three passageways 148, 149 and 150 separated by members 155 and 158. Although not limiting in the present invention, in the particular embodiment members 155 and 158 are spaced apart a distance slightly greater than the width of alignment member 154. The passageways 148, 149 and 150 extend through the body 147 to side 151 opposite to side 146. The outer passageways 148 and 150 each have a nib 152 to capture the tabs 144 of the fingers 139 and 140 in a manner discussed below to releasable secure the injector 132 and the receiver together. The middle passageway 149 receives the alignment member 142. Although not limiting to the invention, receiver 134 has a side cavity 153 to reduce the amount of material needed to form the receiver. End 154 of the alignment member 142 has rounded or mitered corners, and end 156 of the fingers 139 and 140 is rounded for ease of insetting the alignment member and fingers in their respective passageways, and for moving the tabs of the fingers 139 and 140 over their respective nib 152 to move the fingers toward one another. After the tabs 144 move over their respective nib, the fingers 139 and 140 move to their unbiased position. As the fingers move toward their unbiased position, outwardly facing groove 157 of the fingers 139 and 140 move over the adjacent nib to lock or secure the injector 132 and the receiver 34 together. The ends 156 of the fingers 139 and 140 are provided with the holes 120 to allow for biasing of the fingers 139 and 140 toward one another so as to move the tabs over its respective nib as the receiver and the injector are separated. With the nibs 152 in its respective groove 157 of the fingers 139 and 140, plate member or shoulder 159 of the injector 132 is in the passageway 145. The alignment member 154 facilitates the alignment of the fingers with their respective passageway. The shoulder 159 of the injector in the passageway of the receiver 134 and the alignment member 142 in the passageway 149 reduces rocking of the injector 132 and the receiver 134 relative to one another.

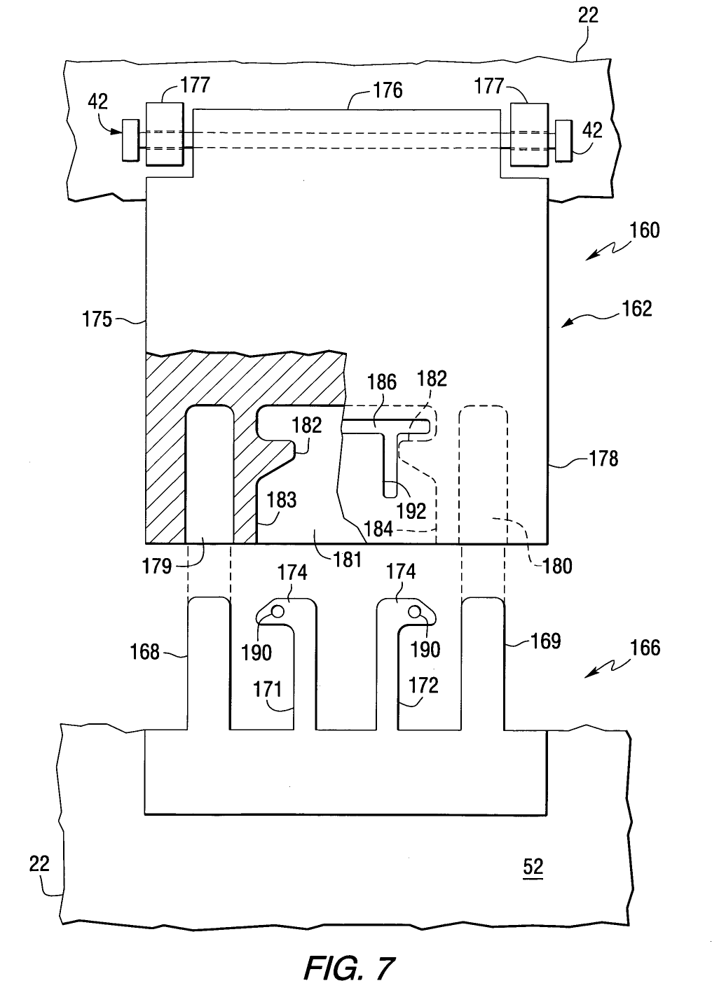

There is shown in FIG. 7, still another non-limiting embodiment of the hinge part having the quick assembly receiver and injector of the invention designated by number 160. The hinge part 160 includes a receiver 162 and an injector 166. The injector 166 is mounted on a surface of the window 22, e.g. the inner surface 52 the window 26. The injector 166 includes a pair of outer alignment members 168 and 169 and two spaced fingers 171 and 172 between the spaced members 168 and 169. The fingers 171 and 172 each have an outwardly extending tab 174. The injector can be mounted on the glass with the alignment members 168 and 169, and the fingers 171 and 172 extending beyond the edge of the window as shown in FIG. 7, or the alignment members and fingers can be located over and spaced from the glass surface so that the receiver 162 can receive the alignment members and the fingers in a manner discussed below.

In the arrangement of FIG. 7, the receiver 162 of the hinge part 160 includes a body 175 having hollow cylinder 176 mounted to the upper portion of the body 175. Extensions 176 are mounted on the automobile, and the pin 42 passes through the extensions 177 and the cylinder 176 to pivotally mount the receiver 162 to the body of the automobile. The hinge part 34 of the door 23 (not shown in FIG. 7) is pivotally mounted to the roof at positions spaced from the positions at which the window is pivotally mounted. The lower end portion 178 of the body 175 of the receiver has a pair of outer passageways 179 and 180 to receive the outer alignment members 168 and 169 respectively, and a center passageway 181 having a nib 182 on each of opposed walls 183 and 184 of the passageway 181 to capture the tabs 174 of the fingers 171 and 172 as previously discussed for the hinge 90 as shown in FIG. 5. The receiver 162 and the injector 166 are joined together by sliding the alignment members 168 and 169 into the passageways 179 and 180, respectively, and the fingers 171 and 172 into the center passageway 181 to move the tabs 174 over the nibs 182. The receiver 164 and injector 166 are separated by inserting end of an elongated rod (shown only in FIG. 5) through horizontal groove 186 as viewed in FIG. 7 into hole 190 in each of the nibs 174 of the fingers 171 and 172. The elongated rods are moved toward one another along the horizontal groove 186 to bias the fingers toward one another to clear its respective nib 181. Thereafter, the receiver and the injector are moved away from one another. The elongated rods move along vertical grooves 192 as viewed in FIG. 7 (only one shown in FIG. 7) and the fingers move out of the passageway 181, moving the tabs 174 past their respective nib 182. Thereafter the elongated rods can be removed from the holes 190 in the tabs and from the vertical groove 192, and the injector 166 and receiver 162 are separated. As can be appreciated, the horizontal groove 186 and vertical grooves 192 can be combined into an opening large enough to bias the fingers toward one another and maintain the fingers toward one another as the tabs move past their respective nibs 182.

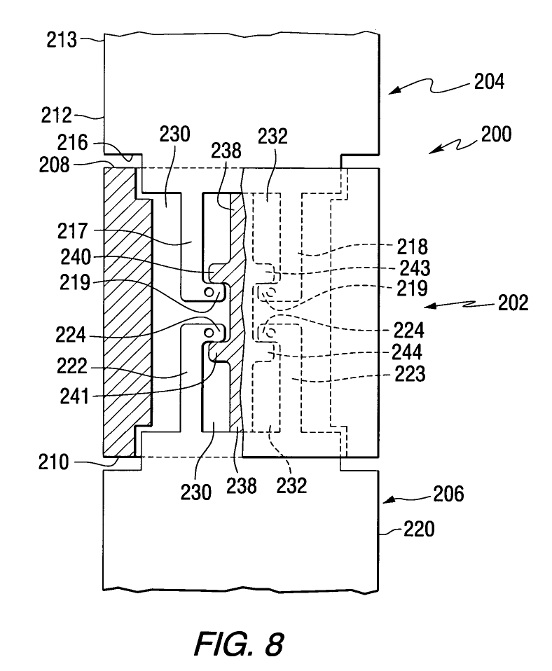

As can be appreciated, the invention is not limited to the non-limiting embodiments of the quick assembly hinge discussed above, and the invention contemplates arrangements having one or more receivers and/or one or more injectors. For example but not limiting to the invention, hinge part having the quick assembly receiver and injector shown in FIG. 8 and designated by the number 200 includes a receiver 202 and two injectors 204 and 206. One side, e.g. side 208 of the receiver 202 is connected to the injector 204 and the other side, e.g. side 210 is connected to the second injector 206. Body 212 of the injector 204 has a pair of spaced extensions or a cylinder (neither shown) at side 213 similar to the spaced members 98 of the hinge 90 shown in FIG. 5 or the cylinder 41 of the hinge 160 shown in FIG. 7 for pivotally mounting the injector 204 to the automobile. Opposite end portion 216 of the body 212 of the injector 204 has a pair of fingers 217 and 218 having inwardly facing tabs 219. The second injector 206 has body 220 securely mounted to the inner surface 52 of the window 26 as discussed above. The body 220 of the injector 206 has a pair of spaced fingers 222 and 223 each having inwardly facing tabs 224.

The receiver 202 has a pair of passageways 230 and 232 extending from the side 208 to the side 210. A wall 238 separates the passageways 230 and 232 and has on each side a pair of spaced nibs, namely nibs 240 and 241 on one side of the wall 238 and facing the passageway 230, and nibs 243 and 244 on the wall and facing the passageway 232. As shown in FIG. 8, when the fingers 217 and 218 of the injector 204 are inserted in the side 208 of the receiver into the passageways 230 and 232, respectively, the tabs 219 of the fingers 217 and 218 pass over the nibs 240 and 241, and the fingers 217 and 218 are captured in the receiver 202. Similarly, when the fingers 222 and 223 of the injector 206 are inserted in the side 210 of the receiver into the passageways 230 and 232, respectively, the tabs 224 of the fingers 222 and 223 pass over the nibs 243 and 244, and the fingers 222 and 223 are captured in the receiver 202. In this manner, the injectors 204 and 206, and the receiver 202 are releasable secured together to pivotally mount the window 24 to the body of the automobile.

The fingers 217 and 218 of the injector 204, and the fingers 222 and 223 of the injector 206 can be removed from their respective passageways in any convenient manner, e.g. by moving the fingers, e.g. fingers 217 and 218 away from one another and/or the fingers 222 and 223 away from one another, e.g. using the groove arrangement, e.g. horizontal groove 186 and vertical groove 192 shown in FIG. 7.

As can be appreciated, the position of the receiver 202 and the injectors 204 and 206 can be interchanged. For example, but not limiting to the invention, a receiver can be pivotally mounted to the body of the automobile, and another receiver secured to the glass. An injector having a pair of spaced fingers with outwardly facing tabs at opposite sides secures the two receivers together to pivotally mount the window on the body of the automobile.

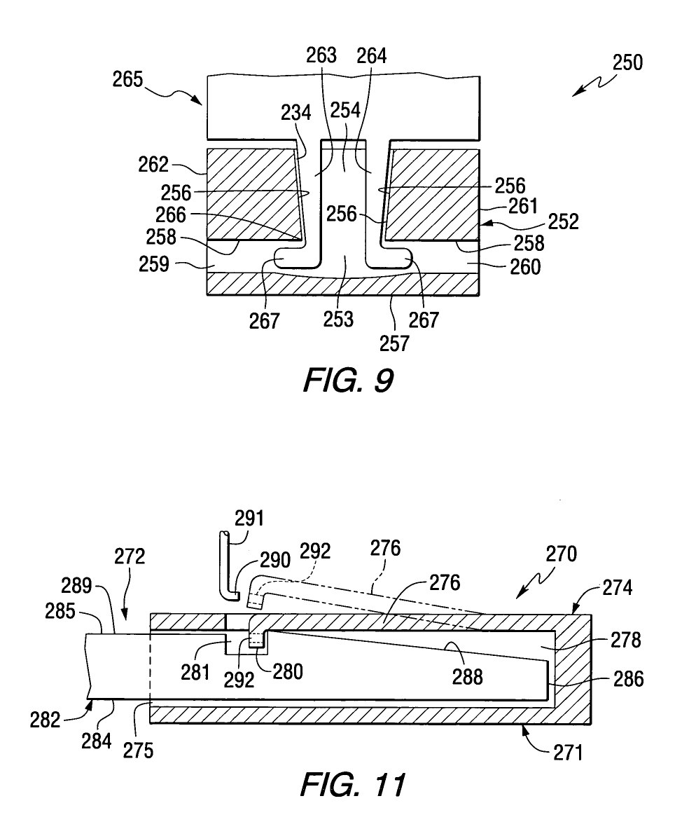

Other embodiment of the hinge part having the quick assembly receiver and injector of the invention contemplates different arrangements to secure the tabs of the injector in the receiver. For example, but not limiting to the invention, and with reference to FIG. 9, the locking arrangement for hinge part designated by the number 250 includes receiver 252 having a “T” shaped passageway 253. The passageway 253 has an open end portion 254 having inwardly sloping walls 256 extending toward side 257 of receiver 252, which intersects portion 258 of passageway 253. Portion 255 extends the width of receiver 252 and includes openings 259 and 260 in each sidewall of the receiver forming a ledge 266. As fingers 263 and 264 having outwardly extending tabs 267 are moved into portion 254 of the passageway 253, the tabs 267 engage the inwardly sloping walls 256 of the passageway 253 to bias the fingers 263 and 264 toward one another. When the tabs move past the transition position 258, the biasing action on the fingers is removed and the tabs of the fingers move into their respective adjacent one of the openings to secure the injector and the receiver together.

The tabs 267 of fingers 263 and 264 are removed from portion 258 of passageway 253 in any convenient manner, e.g. by moving an end of an elongated rod (not shown) through the side of the receiver 252 into each of the openings 259 and 260, respectively into engagement with the tabs 267 of the fingers 263 and 264. The rods are moved toward one another to move the tabs 267 to a position such that tabs 267 can move through portion 254 and the injector and the receiver can be moved away from one another to separate them. As can be appreciated the tabs can be provided with holes for a more positive engagement between the end of the rod and the tabs.

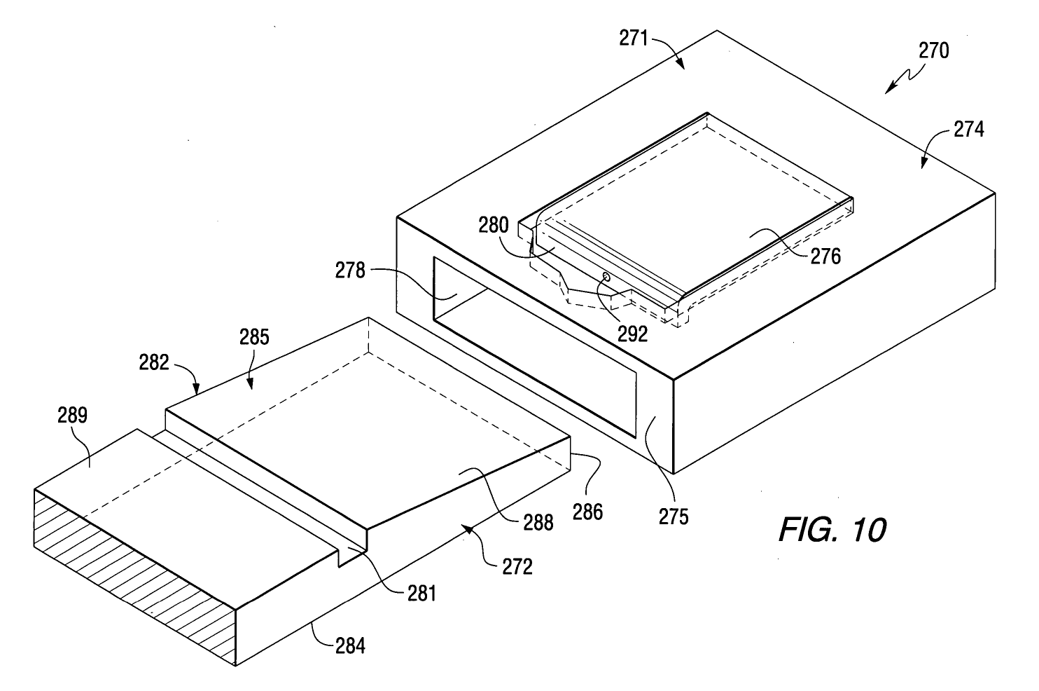

With reference to FIGS. 10 and 11, there is shown another non-limiting embodiment of the hinge part having the quick assembly receiver and injector of the invention designated by the number 270. The hinge part 270 includes a receiver 271 and an injector 272. The receiver 271 or the injector 272 can be pivotally mounted on the body 32 of the automobile 22 as previously discussed, and the injector 272 or receiver 271 can be secured to the window 26 as previously discussed. The receiver 271 includes a housing 274 having an open end 275 to receive the injector 272, and a flexible finger 276 biased toward interior 278 of the housing 274. The finger 276 has an extended ridge or ledge 280 (clearly shown in FIG. 11) that is seated in groove 281 of the injector 272 when the injector is inserted into the housing 274 of the receiver 271 as discussed below.

The injector 272 includes a plate member 282 having a bottom surface 284 and an opposite upper surface 285. The upper surface 285 has the groove 281 spaced from end 286 of the plate member 282. Portion 288 of the upper surface 285 between the groove 281 and the end 286 of the plate member 278 slopes downward for ease of inserting the end 286 into the housing 274 of the receiver 271. Remaining portion 289 of the upper surface 285 of the plate member 282 on the other or left side of the groove 281 as viewed in FIGS. 10 and 11 is preferably, but not limited to the invention, sized to slide into the housing 274 and have minimal spacing, e.g. 1/32 to 1/16 inch between the interior walls of the housing 274 and exterior surfaces of the plate member 282 on the left side of the groove 281 as viewed in FIGS. 10 and 11. In this manner, there is minimal rocking of the plate member when captured in the housing and less fatigue wear on the ledge 280 of the finger 276 of the receiver 271.

In the practice of the invention, but not limiting thereto, the end 286 of the injector 272 is moved into the housing 274 of the receiver 271 and moves the flexible finger 276 upward as shown in phantom in FIG. 11 as the ledge 280 slides along the sloped surface 288 of the injector 272. When the groove 281 moves under the ledge 280, the biasing action of the finger 276 moves the finger downward to move the ledge into the groove 281 of the injector 272 to releasably secure the plate member 282 in the housing 274. The plate member 282 is removed from the housing 274 in any convenient manner, e.g. but not limiting the invention, bent end 290 of elongated member 291 (see FIG. 11) is placed in hole 292 of the ledge 280, and the elongated member 291 moved away from the housing 274 to lift the finger 280 and move the ledge 280 out of the groove 281. The plate member 282 is moved out of the housing 274 to separate the receiver 271 and the injector 272.

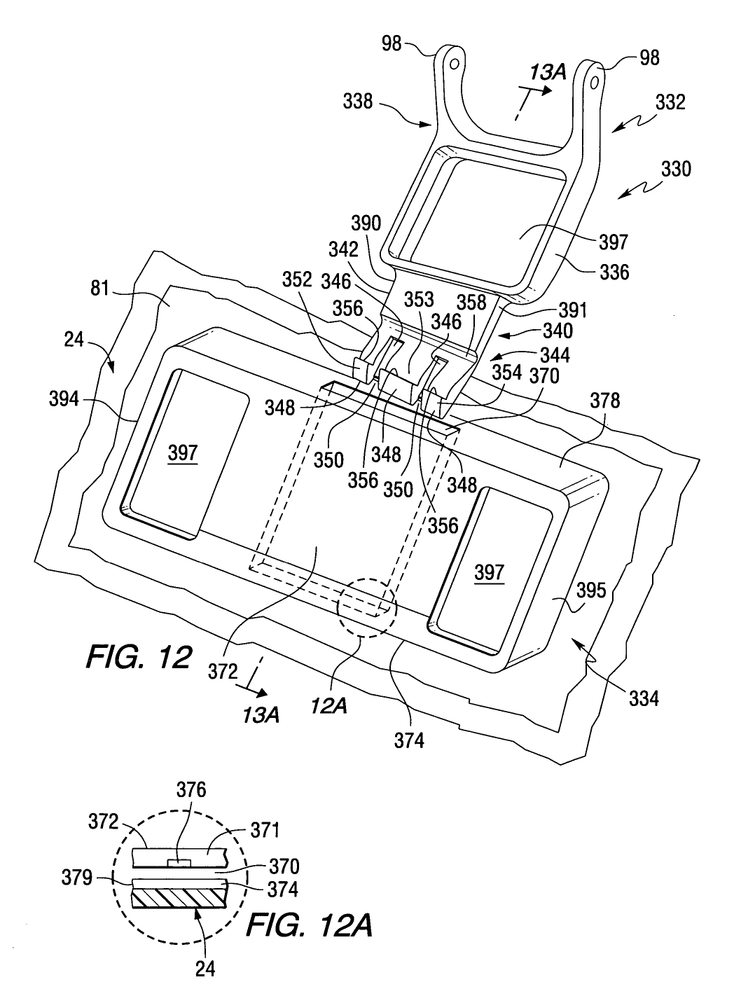

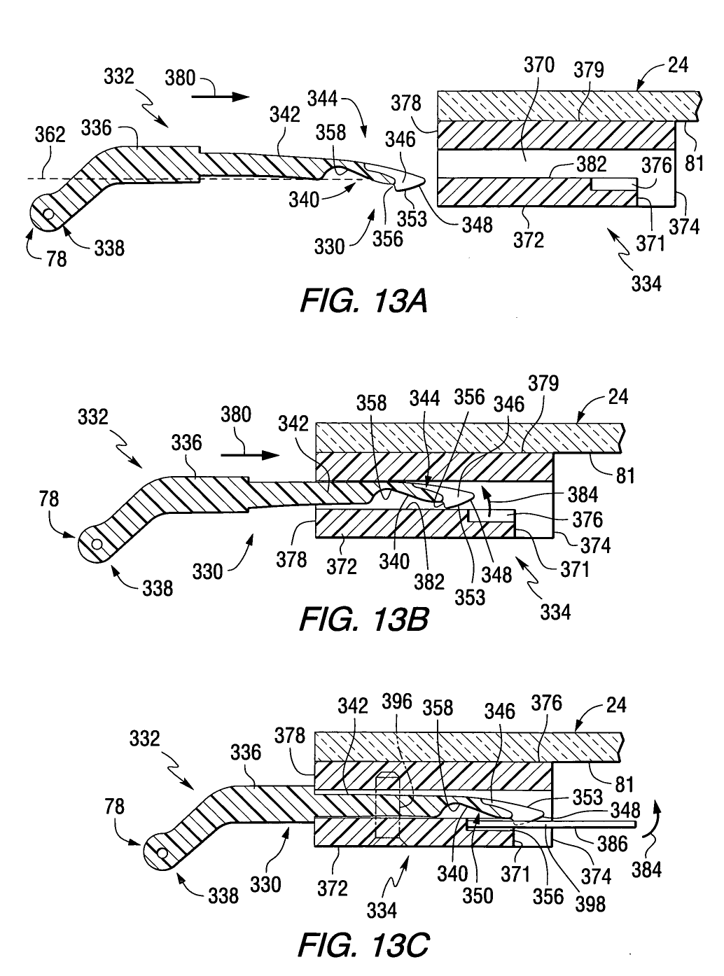

With reference to FIGS. 12, 12A and 13A-13C as needed there is shown another non-limiting embodiment of a hinge part designated by the number 330 having the quick release injector 332 and receiver 334 of the invention. The injector 332 of the hinge part 330 has a body 336 having an upper end portion 338 and a lower end portion 340 as viewed in FIG. 12. The upper end portion 338 has the extensions 98 to pivotally mount the injector 332 to the cylinder 41 by the pin 42 in a similar manner as the extensions 98 of the hinge part 90 shown in FIG. 5 are mounted to the automobile 22 (shown in FIGS. 2 and 3). The lower end portion 340 of the body 336 of the injector 332 has a plate member 342 connecting the body 336 of the injector 332 to an engaging arrangement 344. The engaging arrangement 344 includes a pair of grooves 346 that terminates short of end 348 of the engaging arrangement 344 to provide spacings 350 between ends of fingers 352, 353 and 354 to release the receiver 334 from the injector in a manner discussed below. Although in the practice of the invention, the middle finger 353 is wider than the outer fingers 352 and 354; the invention is not limited thereto, and the fingers can be of equal width, unequal width, or the outer fingers wider than the middle finger.

Adjacent the end 348 of each of the fingers is a cutout 356 to engage the receiver 334 in a manner discussed below. As shown in FIGS. 13A-13C the thickness of the fingers 352, 353 and 354 decreases as the distance from the plate member 342 decreases to a bending location 358. With reference to FIG. 13A with the fingers in the unbiased position, the end 348 and the cutout 356 of each finger 352, 353 and 354 are below plane 362 in which bottom surface of the plate member 342 lies. The fingers 352, 353 and 354 have sufficient flexibility to move the end 348 of each finger upward as viewed in FIG. 13A in a manner discussed below to bend the fingers at the bending location 358 into a biased position shown in FIG. 13B and discussed below.

The receiver 334 has a passageway 370 for receiving the engaging arrangement 344 of the injector 332. End 371 of wall 372 of the passageway 370 terminates short of end 374 of the receiver. A portion of the wall 372 has a pair of spaced grooves 376 (one shown in insert 12A) along passageway 370 that align with the spaced grooves 346 of the engaging arrangement 344 of the injector 332 when the injector and the receiver 334 are in the engaged position discussed below and shown in FIG. 13C. The engaging arrangement 344 of the injector and the passageway 370 of the receiver are sized such that complete insertion of the engaging arrangement in the passageway has the body 336 of the injector 332 adjacent side 378 of the receiver, and the cutout 356 of each finger 352, 353 and 354 engaging end 371 of the wall 372 as shown in FIG. 13C.

With reference to FIGS. 13A-13B as needed, the end 348 of the engaging arrangement 344 of the injector 332 is moved into the passageway 370 of the receiver in the direction of arrow 380 toward the side 378 of the receiver 334. As the body 336 of the injector follows the engaging arrangement into the passageway 370 of the receiver 334, the end 348 engages inner surface 382 of the wall 372 of the passageway 370 and is biased upward in the direction of the arrow 384. Continued movement of the engaging arrangement 344 into the passageway moves the body 336 of the injector 332 adjacent the side 378 of the receiver 334, and the end 348 of the fingers 352, 353 and 354 over the end 371 of the wall 372 of the passageway 370 of the receiver to move the fingers to the unbiased position and move the cutouts 356 in the fingers into engagement with the end 371. In this manner the receiver and the injector are detachably secured together.

The injector 332 is released from the receiver 334 in any convenient manner. For example, but not limiting to the invention, by inserting an elongated member 386 shown in FIG. 13C into the grooves 346 between the fingers 352 and 353 and between the fingers 353 and 354 and into the grooves 376 of the receiver (see FIGS. 12 and 12A). The elongated members (only one shown in FIG. 13C) are moved upward in the direction of the arrow 384 to move the fingers into the biased position and move the cutouts 356 of the fingers away from the end 371 of the passageway 370. After the fingers of the injector clear the end 371 of the passageway, the injector and the receiver are pulled away form one another to separate the injector and the receiver.

The plate member 342 and the engaging arrangement 344 of the injector 332 and the passageway 370 of the receiver are sized such that the plate member 342 following the engaging arrangement into the passageway engages the inner walls of the passageway. In this manner, the ends of the fingers 352, 353 and 354 in surface contact with the inner walls of the passageway are biased upward about the bending location 358 into the biased position and move to the unbiased position after the ends of the fingers exit the passageway to move the cutouts 356 of the fingers over the side 374 of the passageway. Further minimizing the spacing between the inner walls of the passageway 370 and the outer surface of the plate member 342 of the injector 332 minimizes rocking to the injector and receiver relative to one another.

As can be appreciated, the outline of the receiver and injector should be configured to take into account the outline and surface of the window to which they are being mounted. For example but not limiting to the invention and with reference to FIG. 12, the length of side 390 of the plate member 342 is shorter than the length of opposite side 391, and the length of side 394 of the receiver is shorter than the length of opposite side 395. Further, and not limiting to the invention, the body 336 of the injector 334 and body of the receiver 334 are provided with cavities 397 for aesthetics and to reduce the amount of material needed to form the receiver and the injector.

The receiver and the injector shown in FIGS. 12 and 13 were made using the process known as stereo lithographically. The passageway 370 of the receiver 334 had a width of 70 mm and a length of 60 mm; the wall 372 had a depth of 50 mm and the opposite wall 379 had a depth of 60 mm. The plate member 342 of the injector had a thickness of 8 mm, a width of 68 mm; the side 390 had a length of 25 mm and the side 391 had a length of 30 mm. The distance from the cutouts 356 of the fingers 352, 353 and 354 to the bending position 358 is 35 mm. The thickness of the fingers adjacent the cutouts 356 was 8 mm and the thickness adjacent the bending location 358 was 3 mm. The depth of the cutouts was sufficient to engage portions of the end 371 of the wall 372.

As can be appreciated, the cutouts should be of sufficient depth to engage the end 371 of the wall 372 of the passageway 370 and the flexure of the fingers sufficiently rigid to avoid the cutouts from disengaging the end 371 as a result of vibrations. Further in those instances where the automobile is used on a rough or rocky terrain, the injector 332 may be secured in the receiver by a screw 396 shown in phantom in FIG. 13C passing through the wall 372 of the passageway through the plate 342 of the injector into the wall 378 of the passageway. The screw 396 can have a security cap to require removal of the screw by a special tool. In conjunction with the screw 396 or in place of the screw, a shim (not shown) can be provided in the passageway 370 between the fingers 352, 353 and 354 and the inner surface of the wall 378 and held in position by a screw (not shown).

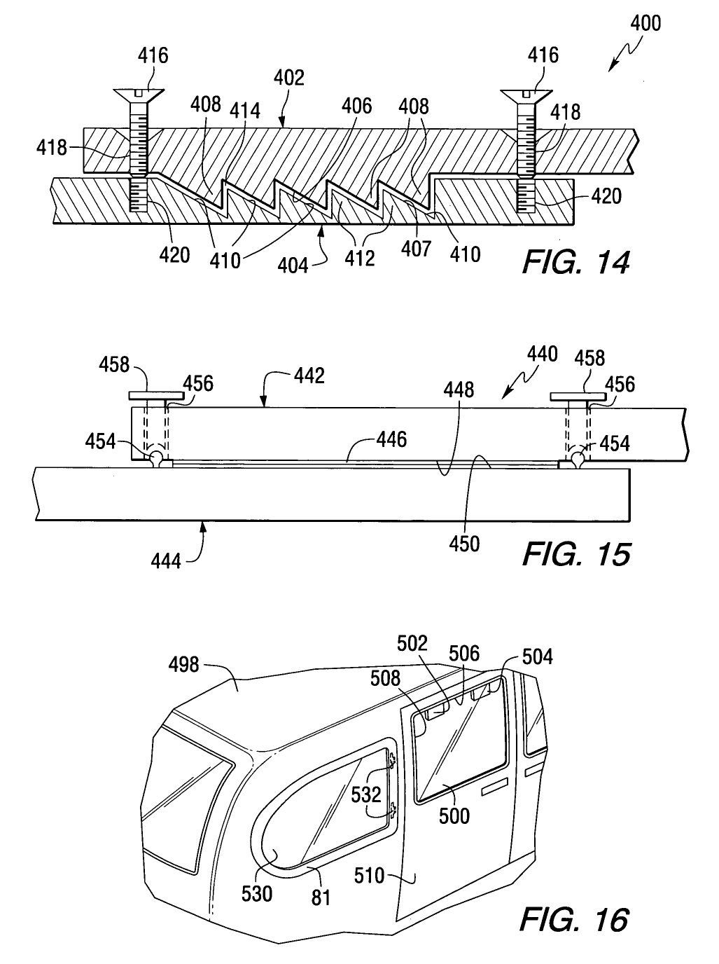

Shown in FIG. 14 is a still further non-limiting embodiment of the hinge part having the quick assembly receiver and injector of the invention designated by the number 400. The hinge part 400 includes a first member 402 and a second member 404. The first member 402 or the second member 404 can be pivotally mounted to the body 32 of the automobile 22, and the member 404 or the member 402 may be secured to the rear window 26, as previously discussed. The members 402 and 404 each having a saw toothed surface 406 that are interlocked as shown in FIG. 14. More particularly, teeth 408 of the saw toothed surface 406 of the member 402 are in grooves 410 of the saw toothed surface 407 of the member 404, and teeth 412 of the saw toothed surface 407 of the member 404 are in the grooves 414 of the saw toothed surface 406 of the member 402. As can be appreciated, either member 402 or 404 can be the receiver or the injector since both members have features of the injector and the receiver. More particularly, the teeth of the member are a feature of the injector and the groove between the teeth is a feature of the receiver. The members 402 and 404 are held together in any convenient manner, for example but not limiting to the invention, by screws 416 passing through passageways 418 in the member 402 and screwed into threaded holes 420 in the member 404. As can be appreciated, the invention not limited to the manner in which the members 402 and 404 are secured together and any known fastening arrangement may be used, e.g. but not limiting to the invention, securing engaging strips sold under the registered trademark Velcro can be used to secure the member 402 and 404 together.

Shown in FIG. 15 is still another non-limiting embodiment of the hinge part having the quick assembly receiver and injector of the invention designated by the number 440. The hinge 440 includes a first member 442 and a second member 444. The first member 442 or the second member 444 can be pivotally mounted to the body 32 of the automobile 22, and the member 444 or the member 442 may be secured to the rear window 26, as previously discussed. The member 442 or the member 444 has one part of a Velcro® attachment arrangement 446 adhered to a major surface, e.g. surface 448 of the member 442, or surface 450 of the member 444, and the member 444 or the member 442 has the other part of the Velcro attachment arrangement adhered to a major surface, e.g. surface 450 of the member 444, or surface 448 of the member 442.

The members 442 and 444 are secured together in any convenient manner to prevent pulling the Velcro arrangement apart, e.g. by the screw and bolt arrangement shown in FIG. 14 or as shown in FIG. 15 by mounting a rounded member 454 on each end portion of one of the members 442 or 444, and receiving holes 456 in the other member 444 or 442. An insert 458 having spaced legs (not shown) is moved into the holes 458 to move the end of the legs of the insert around the rounded member 454 to releasably secure or engage the member 454 in the hole 456. Raising the insert 458 release the member 454, and the members 442 and 444 can be separated by pulling the members apart with sufficient force to separate the Velcro arrangement.

With reference to FIG. 16 there is shown an automobile 498 having additional non-limiting embodiments of the invention. More particularly, window 500 is pivotally mounted at 502 and 504 to topside 506 of window opening 508 of side door 510. The window 500 can be pivotally mounted by mounting a receiver or injector of the invention discussed above to the top side 506 of the door 510 and mounting the injector or receiver, respectively of the hinge part to a surface, e.g. but not limiting to the invention, the inner surface (not shown) of window 500.

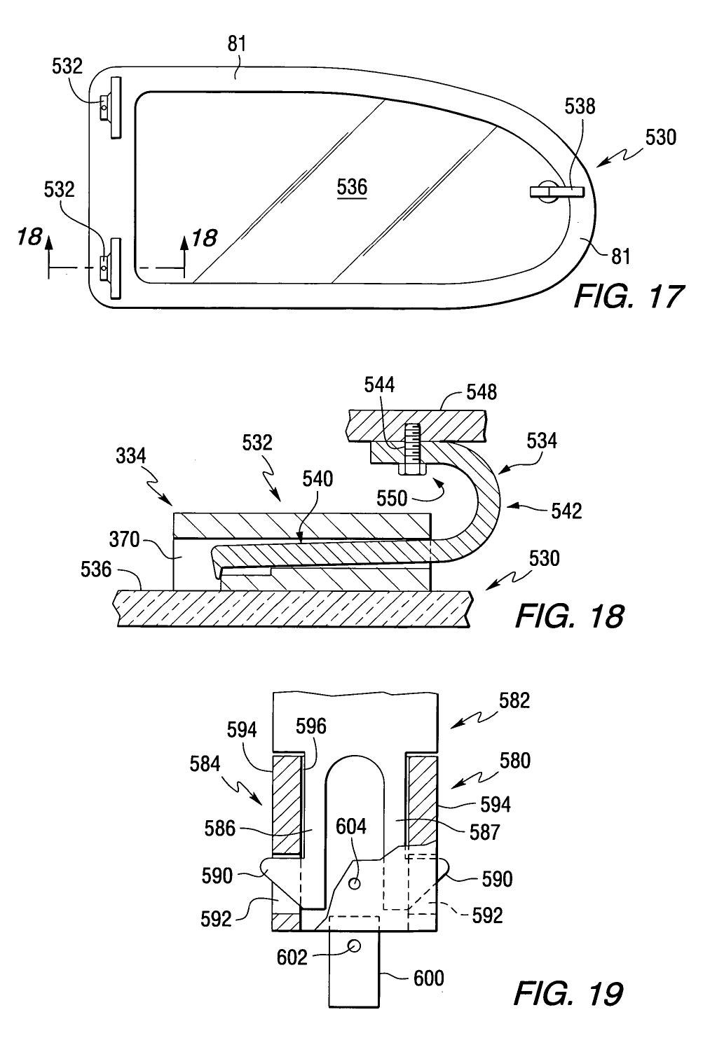

With continued reference to FIG. 16, the invention can be used to pivotally mount quarter panel or side window 530 to the automotive body 498. With reference to FIGS. 16-18 as required, in the following discussion, the window 530 is pivotally mounted to the automotive body 498 by a pair of hinge parts 532 of the invention having the receiver 334 (see FIG. 18), and an injector 534 similar to the injector 332 of the hinge part 330 shown in FIGS. 12, 12a and 13A-13C. The window 530 includes the ceramic band 81 on marginal edge portion of inner surface 536 to hide the receiver 334 from view from outside the automobile. A latch 538 is mounted on the inner surface 536 of the window 530 opposite the hinges 532 to open and close the window. The latch 538 is of the type used in the art and no further discussion is deemed necessary.

With specific reference to FIG. 18, the injector 534 has a lower end portion 540 similar to the lower end portion 340 of the hinge part 330 discussed above and shown in FIGS. 12, 12A and 13A-13C mounted in the passageway 370 of the receiver 334 as discussed above for the hinge part 330. Sides (not shown) of the end portion 540 of the injector 534 are equal in length unlike the sides 390 and 391 of the injector 332 shown in FIG. 12 which are not equal in length. Upper body portion 542 of the injector 534 is curved and has a hole 544 to mount the injector 534 to section 548 of the automotive body adjacent the window opening. The injector is preferably made of spring steel and the curved upper body portion 542 is biased to move the window, e.g. the portion of the window having the latch 538 away from the section 548 of the automotive body. The receiver 334 can be made of any material. Moving the window 530 to the closed position, e.g. moving the portion of the window having the latch toward the section 548 of the automotive body, moves the window against the basing action of the upper body portion 542 of the injector 534.

In the practice of the invention and not limiting to the invention, the upper body 542 of the injector 534 is secured to the section 548 of the automotive body 498 in any usual manner, e.g. by welding by a machine screw 550 as shown in FIG. 18. The end portion 540 of the injector 534 engages the receiver 334 to pivotally mount the window 530 to the automotive body 498, and the end portion of the injector 534 disengages the receiver to remove the window from the automotive body in the manner that the injector 332 engaged and disengaged the receiver 334 discussed above and shown in FIGS. 13A-13C.

In the above discussion, the tabs of the injectors of the non-limiting embodiments of the invention did not extend beyond the outer walls of the receiver. As can now be appreciated, the invention contemplates having portions of the tabs extending beyond the walls of the receiver, e.g. but not limiting to the invention, as shown for the hinge part 580 in FIG. 19 having a quick assembly receiver 582 and injector 584 of the invention. The injector 582 includes a pair of fingers 586 and 587 each having a tab 590 having portions extending through holes 592 of the receiver 584. The holes 592 extend from outer surface 594 of the receiver to passageway 596 in the receiver. In the practice of the invention, the flexible fingers 586 and 587 of the injector are moved into the passageway 596. As the tabs 590 move into the passageway, the fingers 586 and 587 are biased toward one another. When the tabs 590 are aligned with their respective hole 592, the tabs move through the holes as the fingers move to the unbiased position.

Because the tabs are easily accessible, it is recommended that a shim 600 be inserted into the passageway 596 between the fingers 586 and 587. The shim is moved into the passageway of the receiver until hole 602 in the shim is aligned with hole 604 in the receiver. A screw (not shown) is mounted in the holes to secure the shim in position between the fingers 586 and 587 of the receiver to maintain the tabs 590 of the injector in the holes 592 of the receiver and prevent inadvertent separation of the injector from the receiver. The shim 600 is removed from between the fingers of the injector in any usual manner, e.g. by reversing the steps practiced to insert the shim between the fingers.

As can be appreciated, the components of non-limiting embodiments of the hinge part having the quick assembly receiver and injector can be interchanged with one another to provide additional non-limiting embodiments of the hinge part of the invention.

The form of the invention shown and described above represents illustrative non-limiting embodiments of the invention. It is understood that various changes may be made without departing from the teachings of the invention defined by the claimed subject matter that follows.

What is claimed is:

1. A hinge part comprising:
a first member having a first side and an opposite second side, and a channel extending from the first side toward the second side;
a detachably securing arrangement having a first part and a second part, the first part of the securing arrangement accessible through the channel of the first member;
a second member having a first end portion and an opposite second end portion, wherein the first end portion of the second member comprises the second part of the securing arrangement, the first end portion of the second member and the channel of the first member sized relative to one another such that the first end portion of the second member is insertable into the channel of the first member for the first part and the second part of the securing arrangement to engage one another; and
the second side of the first member or the second end portion of the second member having a shaft receiving orifice to mount the second side of the first member or the first end portion of the second member.

2. The hinge part according to claim 1, wherein the first member is defined as a receiver, the second member is defined as an injector; the channel is a passageway, the second part of the securing arrangement at the first end portion of the injector comprises at least one flexible finger having an enlarged portion defined as a tab, and the first part of the securing arrangement comprises a tab engaging portion to engage the tab of the at least one flexible finger.

3. The hinge part according to claim 2, wherein the tab engaging portion of the first part of the securing arrangement is selected from a nib extending into the passageway, an opening in a wall of the passageway to receive the tab of the at least one flexible finger, an orifice extending from an outer surface of the receiver to the interior of the passageway, a portion of the passageway having a decreasing spacing between spaced walls of the passageway as the distance from the first end of the receiver increases to a transition portion where the spaced distance between the spaced wall increases to provide a ledge within the passageway, and combinations thereof.

4. The hinge part according to claim 2, wherein the at least one flexible finger is a first flexible finger, and the injector further comprises a second flexible finger at the first end portion of the injector, the first and second flexible fingers spaced from one another and having outward extending tabs.

5. The hinge part according to claim 4, wherein the tab of the first finger extends away from the second finger and the tab of the second finger extends away from the first finger, and the tab engaging portion of the first part of the securing arrangement comprises a ledge extending from opposed walls of the passageway into the passageway, or an opening in the opposed walls of the passageway to receive the tabs of the flexible fingers.

6. The hinge part according to claim 4, wherein the tab of the first finger extends toward the second finger and the tab of the second finger extends toward the first finger, and the tab engaging portion of the first part of the securing arrangement comprises an intermediate wall within the passageway with first side of the intermediate wall spaced from its adjacent wall of the passageway and opposite second side of the intermediate wall spaced from its adjacent wall of the passageway, the first and second sides of the intermediate wall having a ledge extending outward toward the adjacent wall of the passageway into the passageway, or an opening in the first and second side of the intermediate portion to receive the tabs of the flexible fingers.

7. The hinge part according to claim 4, wherein the tab of the first finger extends toward the second finger and the tab of the second finger extends away from the first finger.

8. The hinge part according to claim 4, further comprising at least one locating member extending away from the first end portion of the injector and spaced from the first and second fingers and wherein the passageway has compartments sized to receive the first and second fingers and the at least one locating member.

9. The hinge part according to claim 8, wherein the at least one locating member is between and spaced from the first and second fingers.

10. The hinge part according to claim 8, wherein the at least one locating member is a first locating member and further comprising a second locating member wherein the first and second locating members are spaced from one another and at least one of the first and second fingers is between the first and second locating members.

11. The hinge part according to claim 2, wherein the first end portion of the injector further comprises at least one locating member spaced from the at least one finger, the passageway of the first member is a first passageway, and the first member further comprises a second passageway spaced from the first passageway for receiving the at least one locating member.

12. The hinge part according to claim 2, wherein the second side of the receiver or the second end of the injector is made of spring steel and is bent to have a “C” shape and forms the shaft receiving orifice.

13. The hinge part according to claim 4, wherein the second side of the receiver or the second end portion of the injector comprises either a pair of spaced extensions, each of the extensions have the shaft receiving orifice, or a cylindrical shaped member having the shaft receiving orifice.

14. The hinge part according to claim 4, wherein the passageway is a first passageway sized to receive the first finger, and further comprising a second passageway spaced from the first passageway to receive the second finger.

15. The hinge part according to claim 14, wherein the first and second passageways have an opening spaced from the first side of the receiver and a third passageway extends from the opening of the first and second passageways to the first side of the receiver, and the first end portion of the injector includes a plate member from which the first and second fingers extend, wherein the plate member and the third passageway are sized relative to one another such that with the first and second fingers in their respective first and second passageways the plate member is in the third passageway and has minimal sideward motion.

16. The hinge part according to claim 4, wherein the receiver has an opening making a portion of at least one of the fingers externally accessible through the receiver when the first and second parts of the securing arrangement are engaged.

17. The hinge part according to claim 16, wherein at least one of the flexible fingers has a hole externally accessible through the opening of the receiver when the first and second parts of the securing arrangement are engaged.

18. The hinge part according to claim 17, wherein the opening in the receiver extends from an end of the receiver to an adjacent wall of the passageway such the hole in the at least one flexible finger is aligned with the opening in the receiver when the first and second fingers are in their respective passageway.

19. The hinge part according to claim 1, wherein the first member is defined as a receiver, the second member is defined as an injector, the passageway extends through the receiver from the first side toward the second side of the receiver, and the first part of the securing arrangement is an outer edge of the passageway spaced from the first side of the receiver defined as a ledge, the second part of the securing arrangement is a cutout adjacent an end of a flexible finger, wherein the first end portion of the injector has a length and the passageway has a depth that are sized relative to one another such that with the flexible finger in the passageway, the cutout of the flexible finger engages the ledge to detachably secure the receiver and the injector together.

20. The hinge part according to claim 19, wherein the flexible finger is one finger of a plurality of flexible fingers with selected ones of the plurality of flexible fingers having a cutout adjacent an end of the selected ones of the plurality of flexible fingers.

21. The hinge part according to claim 20, wherein the ledge of the passageway is between and spaced from the first and second sides of the receiver.

22. The hinge part according to claim 21, wherein the second end portion of the injector includes a plate member lying in a horizontal plane with the plurality of fingers extending from the plate member at an angle to the horizontal plane such that the cutouts are spaced from the plane, the passageway and the plate member are sized relative to one another such that with a portion of the plate member in the passageway, the ends of the plurality of flexible fingers are biased toward the horizontal plane and with additional portions of the plate member in the passageway, the cutouts of the selected ones of the plurality of flexible fingers engage the ledge.

23. The hinge part according to claim 22, wherein the passageway adjacent the ledge has a pair of spaced grooves and the first end portion of the injector has spaced grooves aligned with the grooves of the receiver when the cutouts of the selected ones of the plurality of flexible fingers engage the ledge.

24. The hinge part according to claim 23, wherein each of the plurality of flexible fingers have a cutout, a space is between each of the fingers that extends a predetermined distance from the end of the fingers toward the plate member and connected to a groove, wherein when the receiver and the injector are engaged, selected ones of the grooves of the injector overlay selected ones of the grooves of the passageway and are accessible through the space between the fingers.

25. The hinge part according to claim 24, wherein the second end portion of the injector has a pair of spaced extensions with each of the extensions having a shaft receiving orifice, and the injector is made of spring steel.

26. The hinge part according to claim 4, further comprising a shim between the fingers to maintain the fingers spaced from one another.

27. A hinge part comprising:
a receiver having a passageway extending from one end of the receiving member towards an opposite end, an opening in a side of the receiving member extending from the side to the passageway and a flexible member mounted at one end to the side of the receiving member and having a ridge at the other end, the flexible member in the unbiased position having the ridge extending into the passageway;
an injector having a first end portion and an opposite second end portion, the first end portion having a sloping surface toward a first end of the injector and a groove spaced from the first end, the first end portion sized to be inserted into the receiving member, wherein as the first end moves into the passageway of the receiving member, the ridge is moved against biasing action of the flexible member until the groove of the injector is aligned with the ridge at which time the ridge moves into the groove by the biasing action of the flexible member to releasably secure the receiver and the injector together; and
the receiver or the injector having a shaft-receiving orifice to mount the receiver or the injector.

28. The hinge part according to claim 27, further comprising a hole in the ridge to move the finger away from the passageway.

29. A hinge part comprising:
a first member and a second member, the first and second member each having a first end portion and an opposite second end portion with a center portion between the end portions, the center portion of the first and second members having a saw tooth surface with the saw tooth surface of the first member and the saw tooth surface of the second member sized to inter lock with one another and the end portions having a securing arrangement to secure the first member to the second member with the saw tooth surfaces interlocked; and
the first or the second member having a shaft engaging portion to pivotally mount the member having the shaft engaging portion.

30. A hinge part comprising:
a first member having a first end portion and an opposite second end portion and a center portion between the end portions of the first member;
a second member having a first end portion and an opposite second end portion and a center portion between the end portion of the second member surface;
a first part of a Velcro strip secured to the center portion of the first member;
a second part of the Velcro strip on the center portion of the second member;
a two part first engaging arrangement, the first part of the first engaging arrangement mounting the first end portion of the first member and the second part of the first engaging arrangement mounting the first end portion of the second member;
a two part second engaging arrangement, the first part of the second engaging arrangement mounting the second end portion of the first member and the second part of the second engaging arrangement mounting the second end portion of the second member; and
the first member or the second member having a shaft engaging portion to mount the first member or the second member having the shaft engaging portion.

31. The hinge part according to claim 30, wherein the first part of the first and second engaging arrangement comprises a member having rounded surface portions mounted on the first end portion of the first and second member, and the second part of the first and second engaging arrangement comprises a recess for receiving the member having the rounded surface portions in the second end portion of the first and second members.

32. An article comprising:
a sheet member having a surface, the sheet member selected from the group of windows, doors, pivotally mount rigid substrates and combinations thereof and the sheet member made of a material selected from glass, glass ceramic, plastic, wood, metal, composite material and combinations thereof; and
at least one hinge part mounted on the surface of the sheet member, the hinge part selected from: (1) a receiver having a first side and an opposite second side, and a passageway extending from the first side toward the second side; a tab engaging portion in the passageway, wherein the tab engaging portion is selected from a nib extending into the passageway, an opening in a wall of the passageway to receive a tab of a flexible finger, a portion of the passageway having a decreasing spacing between spaced walls of the passageway as the distance from the first end of the receiver increases to a transition area where the spaced distance between the spaced wall increase to provide a ledge within the passageway, and combinations thereof, and (2) an injector having a first end portion and an opposite second end portion, wherein the first end portion comprises an attachment member having at least one flexible finger having an enlarged end portion.

33. The article according to claim 32, wherein the at least one flexible finger of the injector is a first flexible finger and the injector further comprises a second flexible finger at the first end portion of the injector, the first and second flexible fingers spaced from one another and having extending tabs.

34. The article according to claim 32, wherein the passageway of the receiver extends through the receiver from the first side toward the second side of the receiver, with an outer edge of the passageway spaced from the first side of the receiver defined as a ledge, the flexible finger of the injector is one finger of a plurality of fingers with selected ones of the plurality of fingers having a cutout adjacent an end of the selected ones of the plurality of fingers, the ledge of the passageway of the receiver is between and spaced from the first and second sides of the receiver, the second end portion of the injector includes a plate member lying in a horizontal plane with the plurality of fingers extending from the plate member at an angle to the horizontal plane such that the cutouts are spaced from the plane, and the passageway adjacent the ledge has a pair of spaced grooves, wherein the first portion of the injector has spaced grooves aligned with the grooves of in the passageway when the cutouts of the selected ones of the plurality of fingers engage the ledge.

35. In a vehicle of the type having a part that is pivotally mounted by a mounting arrangement comprising at least one hinge part mounted to a surface of the part and pivotally mounted to the vehicle body or pivotally mounted to a component mounted to body of the vehicle, the improvement comprising:
a quick release hinge part comprising a first member, a second member, and a releasably securing arrangement, with the first member or the second member mounted to the surface of the part and the second member or the first member, respectively, pivotally mounted to the vehicle body or a component mounted to the vehicle body, wherein
the first member has a first side and an opposite second side, and a passageway extending from the first side toward the second side;
the detachably securing arrangement has a first part and a second part, the first part of the securing arrangement accessible through the passageway of the first member;
the second member has a first end portion and an opposite second end portion, wherein the first end portion of the second member comprises the second part of the securing arrangement, the first end portion of the second member and the passageway of the first member sized relative to one another such that the first end portion of the second member is insertable into the passageway of the first member for the first part and the second part of the securing arrangement to engage one another; and
the second side of the first member or the second end portion of the second member pivotally mounted to the vehicle body or pivotally mounted to a component mounted to the vehicle body.

36. The vehicle according to claim 35, wherein the first member is defined as a receiver, the second member is defined as an injector, the second part of the securing arrangement at the first end portion of the injector comprises at least one flexible finger having a tab, and the first part of the securing arrangement comprises a tab engaging portion within the receiver to engage the tab of the at least one flexible finger.

37. The vehicle according to claim 35, wherein the first member is defined as a receiver, the second member is defined as an injector, the passageway extends through the receiver from the first side toward the second side of the receiver, and the first part of the securing arrangement is an outer edge of the passageway spaced from the first side of the receiver defined as the ledge, the flexible finger is one finger of a plurality of flexible fingers, the second part of the securing arrangement is a cutout adjacent an end of selected ones of the plurality of flexible finger, wherein length of the first end portion of the injector and the depth of the passageway are sized relative to one another such that with the flexible finger in the passageway, the cutout of the finger engages the ledge to detachably secure the receiver and the injector together, the ledge of the passageway is between and spaced from the first and second sides of the receiver, the second end portion of the first end portion of the injector includes a plate member lying in a horizontal plane with the plurality of fingers extending from the plate member at an angle to the horizontal plane such that the cutouts are spaced from the plane, the passageway and the plate member are sized relative to one another such that with a portion of the plate member in the passageway, the ends of the plurality fingers are biased toward the horizontal plane and with additional portions of the plate member in the passageway, the cutouts of the selected ones of the plurality of fingers engage the ledge, the passageway adjacent the ledge has a pair of spaced grooves and the second portion of the injector has spaced grooves with the grooves of the passageway aligned with the grooves of the injector when the cutouts of the selected fingers engaged the ledge, and the second portion of the injector has a pair of spaced extensions with each of the extensions having a shaft receiving orifice, each of the plurality of fingers have a cutout, a space is between each of the fingers that extends a predetermined distance form end of the fingers toward the plate member and connected to a groove, wherein when the receiver and the ejector are together the certain ones of the grooves of the ejector over lay certain ones of the grooves of the passageway and are accessible through the space between the fingers.

38. A method of separating a first and second article, the first article pivotally mounted to the second article, the first article made of a material selected from the glass, glass ceramic, plastic, wood, metal, composite material and combinations thereof, the first article having a first section of a hinge part mounted on a surface of the first article and the second article has an end portion of a second section of the hinge part mounted thereto, the first and second sections of the hinge part are detachable secured to each other by at least one flexible finger attached to the first or second section of the hinge part, and the second or first section of the hinge part, respectively, having a finger engaging portion, wherein the finger engaging portion engages the finger, comprising the steps of:
moving the at least one finger away from the finger engaging portion defined as a first moving step; while
moving the first and second sections of the hinge part relative to one another defined as a second moving step to separate the first and second sections of the hinge part.

39. The method according to claim 38, wherein the first article is a window or portions of a broken window of a land vehicle and the second article is a body portion of the land vehicle.

40. The method according to claim 38, wherein the first section of the hinge part is a receiver having the finger engaging portion, the end portion of the second section of the hinge part is pivotally mounted to the second article, and the second section of the hinge part is an injector having the at least one finger; the hinge part is a first hinge part, and further comprising a second hinge part having a receiver having a finger engaging portion and an injector having at least one flexible finger and an end portion with the end portion of the injector of the second hinge part pivotally mounted to the automobile body spaced from the injector of the first hinge part and the method further comprises the step of after the practice of the first moving step, moving the at least one finger of the injector of the second hinge away from the finger engaging portion of the receiver of the second hinge and moving the receiver and the injector of the second hinge part relative to one another defined as third moving step to separate the injector and the receiver of the second hinge part.

41. A method of securing a first article to a second article, the first article made of a material selected from glass, glass ceramic, plastic, wood metal and combinations thereof, the first article having a first section of a hinge part mounted on a surface of the first article and the second article has a portion of a second section of the hinge part mounted thereto, the first and second sections of the hinge part are detachable secured by at least one flexible finger attached to the first or second section of the hinge part, and the second or first section of the hinge part, respectively, having a finger engaging portion, wherein the finger engaging portion engages the finger, comprising the step of:
moving the finger and the finger engaging portion toward and into engagement with one another to secure the first and second sections of the hinge part together.

42. The method according to claim 41, wherein the first article is a window or portions of a broken window of a land vehicle and the second article is a body portion of the land vehicle.

43. The method according to claim 42, wherein the first section of the hinge part is a receiver having the finger engaging portion and mounted on a first surface of the window, the end portion of the second section of the hinge part is pivotally mounted to the automobile, and the second section of the hinge part is an injector having the at least one finger; the hinge part is a first hinge part, and further comprising a second hinge part having a receiver having a finger engaging portion mounted on the first surface of the window spaced from the receiver of the first hinge part and an injector having at least one flexible finger and an end portion with the end portion of the injector of the second hinge part pivotally mounted to the automobile body spaced from the injector of the first hinge part further comprising after the practice of the first moving step, practicing the step of moving the finger of the injector of the second hinge part and the receiver of the second hinge part toward and into engagement with one another to secure the first and second sections of the second hinge part together.
